(19) United States
(12) Patent Application Publication
(10) Pub. No.: US 2014/0353238 A1
(43) Pub. Date: Dec. 4, 2014

(54) SILVER-COATED FABRIC FOR FILTER MEMBRANE INTEGRATION

(71) Applicant: Goodrich Corporation, Charlotte, NC (US)

(72) Inventor: Jin Hu, Hudson, OH (US)

(21) Appl. No.: 13/907,264

(22) Filed: May 31, 2013

(51) Int. Cl. B01D 71/02; B01D 67/00; C02F 1/50

(52) U.S. Cl. CPC B01D 71/022; C02F 1/505; B01D 67/0002
USPC 210/295; 210/500.25; 210/491; 156/308.2

(57) ABSTRACT

The invention provides a method of preparing a filter medium by thermally bonding silver-coated spunbonded nonwoven fabrics to a dirt-retaining membrane, a chemical-retaining membrane, a pathogen-retaining membrane, or a combination thereof. The invention also relates to the use of one or more silver-coated spunbonded nonwoven fabric layers as a component of a microorganism-killing membrane in filter media for a fluid filtration system. The filter media of the invention offers efficient disinfection effects, maintaining a low pressure drop and a high flow rate when in use. Further, the filter media is adhesive free and contains at least one thermal binding layer made of spunbonded nonwoven polymeric fabrics. The invention also features a water-purification cartridge and the use thereof in a potable water system.

### BACKGROUND

In an aircraft, a potable water system is generally used to supply cabin outlet facilities (e.g., handwash basins in lavatories and sinks in onboard kitchens) with fresh water. Such a potable water system may use water filter media (e.g., pathogen-retaining filter media) combined with biocide-containing nanofiber fabrics to kill pathogens contained in the water or air (see US patent application US 2011/0297609 A1).

However, when the potable water system uses biocide-containing nanofiber fabrics bound via adhesive layers to the filter media for disinfestation, it has been found that the incorporation of the nanofiber fabrics and the adhesive layers, no matter how thin they are, usually causes a significant drop in the water flow rate and also in the water pressure. Thus, there is a need for the development of a new type of filtration system that can be used in a potable water system in the aviation field. It is desired that such a filtration system offers efficient disinfection effects while achieving a low pressure drop and a high flow rate when in use.

### SUMMARY

The invention provides a novel type of filter media that offers efficient disinfection effects, which also achieves a low water pressure drop and a high water flow rate when in use. Specifically, the filter media of the invention includes a microorganism-killing membrane that contains a spunbonded nonwoven polymeric fabric coated with silver and a thermal binding layer.

Advantageously, the filter media of the invention is adhesive free (i.e., containing no adhesive layers or pastes).

In one embodiment, the spunbonded nonwoven polymeric fabrics coated with silver can be polyester fabrics, polypropylene fabrics, polyurethane fabrics, polyimide fabrics, or a combination thereof. In certain instances, the spunbonded nonwoven polymeric fabrics are polyester fabrics, such as, Reemay® spunbonded polyester nonwoven fabrics (e.g., Reemay® 2004 and Reemay® 2250, available from Fiberweb Filtration PLC, Old Hickory, Tenn.)

In another embodiment, the thermal binding layer employed herein can be composed of spunbonded nonwoven polymeric fabrics, such as, polyester fabrics, polypropylene fabrics, polyurethane fabrics, polyimide fabrics, or a combination thereof. In certain instances, the spunbonded nonwoven polymeric fabrics are polyester fabrics, such as, Reemay® spunbonded polyester nonwoven fabrics (e.g., Reemay® 2004 and Reemay® 2250, available from Fiberweb Filtration PLC, Old Hickory, Tenn.).

In a separate aspect, the invention provides a method of preparing a filter media, comprising thermally binding silver-coated spundbonded nonwoven fabrics to at least one membrane selected from the group of a dirt-retaining membrane, a chemical-retaining membrane, and a pathogen-retaining membrane, or a combination thereof, wherein said silver-coated spunbonded nonwoven fabrics are prepared through depositing a silver film onto spunbonded nonwoven fabrics.

In certain embodiments, the silver film can be deposited onto the spunbonded nonwoven fabrics through a chemical vapor deposition, a physical vapor deposition, or a sol gel deposition, or a combination thereof. Chemical vapor deposition includes, but is not limited to, a vacuum vapor deposition, and a combustion chemical vapor deposition.

The invention also provides a novel method for thermally binding silver-coated spunbonded nonwoven fabrics to a membrane selected from the group of a dirt-retaining membrane, a chemical-retaining membrane, and a pathogen-retaining membrane, or a combination thereof.

Another aspect of the invention provides a water-purification cartridge that contains the filter media of the invention.

The invention also features a potable water system containing the water-purification cartridge of the invention.

When in use, the filter media according to the invention offers advantages, such as, maintaining a high water flow rate and a low water pressure drop. The filter media of the invention is also highly efficient in achieving good disinfection effects. Thus, the filter media of the invention can be used as an add-on component to dirt/chemical filter cartridges currently used in aircraft potable water systems to meet the requirements of disinfection without slowing down water flow rate and increasing water pressure drop.

### BRIEF DESCRIPTION OF THE DRAWINGS

FIG. 1 shows a process of producing a silver coated Reemay® (“SR”) film by depositing a thin silver coating onto a Reemay® layer (“R”).

FIG. 2 demonstrates a process of making a SR/R/P membrane by thermally laminating a SR film onto a pathogen-retaining media (“P”) via a separate thermal binding layer of Reemay® fabric: the resulting assembly (SR/R/P) is capped from both sides with Reemay® layers for protection.

FIG. 3 demonstrates a process of making a SR/P membrane by thermally laminating a SR film onto a pathogen-retaining media without a separate thermal binding layer of Reemay® fabric: the resulting assembly (SR/P) is capped from both sides with Reemay® layers for protection.

FIG. 4 shows a process of producing a D/R/SR/R/P membrane by thermally binding a SR/R/P film onto a dirt/chemical holding filter via a separate thermal binding layer of Reemay® fabric: the resulting assembly (D/R/SR/R/P) is capped from both sides with Reemay® layers for protection.

FIG. 5 shows a process of producing a D/SR/P membrane by thermally binding a SR/P film onto a dirt/chemical holding filter (“D”) without a separate thermal binding layers of Reemay® fabric: the resulting assembly (D/SR/P) is capped from both sides with Reemay® layers for protection.

FIG. 6 shows a process of producing a SR/R/SR membrane by thermally binding two SR film via a separate thermal binding layer of Reemay® fabric: the resulting assembly (SR/R/SR) is capped from both sides with Reemay® layers for protection.

FIG. 7 shows a structure having multiple rolls of biocidal fabrics incorporated inward of a dirt/chemical retaining filter cartridge.

FIG. 8 shows a structure having multiple-turn rolls of biocidal fabrics incorporated outward of a dirt/chemical retaining filter cartridge.

### DETAILED DESCRIPTION

The invention provides a novel method of preparing a filter media, comprising thermally binding silver-coated spunbonded nonwoven fabrics to at least one membrane selected from the group of a dirt-retaining membrane, a chemical-retaining membrane, and a pathogen-retaining membrane, or a combination thereof, wherein said silver-coated spunbonded nonwoven fabrics are prepared by depositing a silver film onto nonwoven fabrics.

In one embodiment, the silver film can be deposited onto the spunbonded nonwoven fabrics through a chemical vapor deposition, a physical vapor deposition, or a sol gel deposition, or a combination thereof.

Chemical vapor deposition includes methods, such as, traditional vacuum vapor deposition (CVD) and combustion chemical vapor deposition (CCVD) by nGima Company (www.nGimat.com). Physical vapor deposition (PVD) is performed, for example, by magnetron sputtering or electron beam.

In certain embodiments, the chemical vapor deposition used herein is a vacuum vapor deposition or a combustion chemical vapor deposition.

It is contemplated that other biocidal materials can be deposited onto the spunbonded nonwoven fabrics. The resulting biocidal-coated spunbonded nonwoven fabrics can replace the silver-coated spunbonded nonwoven fabrics used herein. The biocidal deposition can be achieved, for example, by a chemical vapor deposition, a physical vapor deposition, or a sol gel deposition, or a combination thereof.

The thickness of the silver coating can be in a nano-range, generally between about 1 nm and 1,000 nm. By coating the spunbonded nonwoven fabrics with a silver film, the use of biocidal nano-particles can be avoided. Accordingly, the invention provides a nano-particles leach-free method.

The utility of the silver coated fabrics as above delineated avoids the use of nanoparticles or biocidal additive chemicals, which require a subsequent leach of nanoparticles or biocidal additive chemicals. Generally, the silver coatings used herein are not soluble. Thus, the possibility of having leaching issues in the process is low.

In a separate aspect, the invention provides a method of preparing a filter media. The method comprises thermally binding silver-coated spunbonded nonwoven fabrics to at least one membrane, such as, a dirt-retaining membrane, a chemical-retaining membrane, and a pathogen-retaining membrane, or a combination thereof. The silver-coated spunbonded nonwoven fabrics used herein are prepared through depositing a silver film onto spunbonded nonwoven fabrics.

Further, the invention relates to the use of spunbonded nonwoven fabrics that are coated with a silver film (or other biocidal film forming material), which are either directly thermally bound to pathogen-retaining filter media or via a thermal binding layer onto pathogen-retaining filter media, for providing filter media with enhanced pathogen killing efficacy. Alternatively, the invention provides filter media comprising multiple turns of silver-coated spunbonded nonwoven fabrics for providing pathogen killing efficacy.

Accordingly, the invention provides filter media comprising a microorganism-killing membrane. The microorganism-killing membrane includes a thermal binding layer (also referred to as a spunbonded nonwoven fabric) and the silver-coated spunbonded nonwoven fabrics. According to the invention, the filter media does not contain an adhesive layer or adhesive pastes.

Various spunbonded nonwoven polymeric fabrics can be used, including, for example, polyester fabrics, polypropylene fabrics, polyurethane fabrics, polyimide fabrics, or a combination thereof. Other polymers or combinations thereof that have high Fraizer permeability or high TEXTest permeability can also be used (Fraizer Air Permeability Tester or TEXTest tester can be used for standard air permeability test, ASTM D737).

For example, the spunbonded nonwoven polymeric fabrics for use in the thermal binding layer can be polyester fabrics. Exemplified spunbonded nonwoven polymeric fabrics that are used in the invention include, for example, Reemay® spunbonded polyester fabrics.

Reemay® spunbonded polyester can be obtained as a sheet structure of continuous filament polyester fibers that are randomly arranged, highly dispersed, and bonded at the filament junctions. The chemical and thermal properties of Reemay® polyester fabrics are essentially those of polyester fiber. The fibers' spunbonded structure offers a combination of physical properties, such as, high tensile and tear strength, non-raveling edges, excellent dimensional stability, no media migration, good chemical resistance, and controlled arrestance and permeability. Reemay® fabrics are used in various industries as covers (e.g., garden blankets) or support materials.

Reemay® spunbonded polyester fabrics include either straight or crimped polyester fibers which give the fabrics different filtration and other general performance properties. It is believed that crimped fibers offer properties of softness, conformability, and greater porosity, while straight fibers yield stiffness, tighter structure, and finer arrestance.

In certain embodiments of the invention, the Reemay® spunbonded polyester fabrics used herein are straight polyester fabrics. Exemplified Reemay® spunbonded polyester fabrics include, for example, Reemay® spunbonded polyester nonwovens 2004 (or “Reemay® 2004”), and Reemay® spunbonded polyester nonwovens 2250 (or “Reemay® 2250”). These Reemay® fabrics are filtration grade spunbonded polyester fabrics: for Reemay® 2004, thickness 5.0 mil, Fraizer 1400 cfm/ft²; for Reemay® 2250, thickness 5.0 mil, Fraizer 1080 cfm/ft².

According to the present invention, the filter media may further include pathogen-retaining filter media, dirt holding filter media, or chemical holding filter media, or a combination thereof.

In certain embodiments, the filter media of the invention includes pathogen-retaining media. The microorganism-killing membrane is thermally bound to the pathogen-retaining media via the same thermal binding layer or via another thermal binding layer.

In other embodiments of the invention, the filter media includes dirt/chemical holding filter media, and optionally one or more additional thermal binding layers. When pathogen-retaining media are also included, the microorganism-killing membrane is thermally bound via the thermal binding layers to both the pathogen-retaining medium and the dirt/chemical holding filter media via different surfaces.

As known in the art, adhesives block some pores of media and biocide sites, further causing reduced flow rate and high pressure drops in a filtration system. By using thin Reemay® fabrics as binders in the filter media, the use of chemical adhesives can be eliminated. Further, the use of Reemay® fabrics also makes it possible to fabricate the fabrics contained in the filter media.

According to the invention, a microorganism-killing membrane that contains silver-coated fabrics (such as, silver coated Reemay® fabrics) can be rolled up by multiple turns on a screen roll, which is then placed inward of a dirt/chemical holding filter media (or cartridge). Alternatively, the microorganism-killing membrane of the invention can be rolled up and placed outside of the dirt/chemical holding filter media (or cartridge). The specific design of the roll-up forms depends upon the water-flow direction in a specific water system.

Further, rolled-up silver-coated fabrics may contain multiple microorganism-killing membranes of the invention. The rolled-up biocide-containing fabrics can be placed inward of a dirt/chemical holding filter media (or cartridge), or outside of the dirt/chemical holding filter media (or cartridge), depending on the water-flow direction.

The invention further features a water-purification cartridge containing the filter media of the invention.

Also provided is a potable water system containing the water-purification cartridge of the invention. Generally, a potable water system includes components, such as, a water storage tank, a pump, a supply line, a water-purification device (such as, a water-purification cartridge). For a detailed description on potable water systems and functions thereof, see US 2011/0297609.

A variety of configurations according to the invention are presented in the drawings. In these drawings, Reemay® 2250 is provided as an example of spunbonded nonwoven polymeric fabrics that are used for a thermal binding layer (a thermal binder). The invention covers the use of other types of spunbonded nonwoven polymeric fabrics as silver-coated fabrics and a thermal binding layer and the use of other types of biocides.

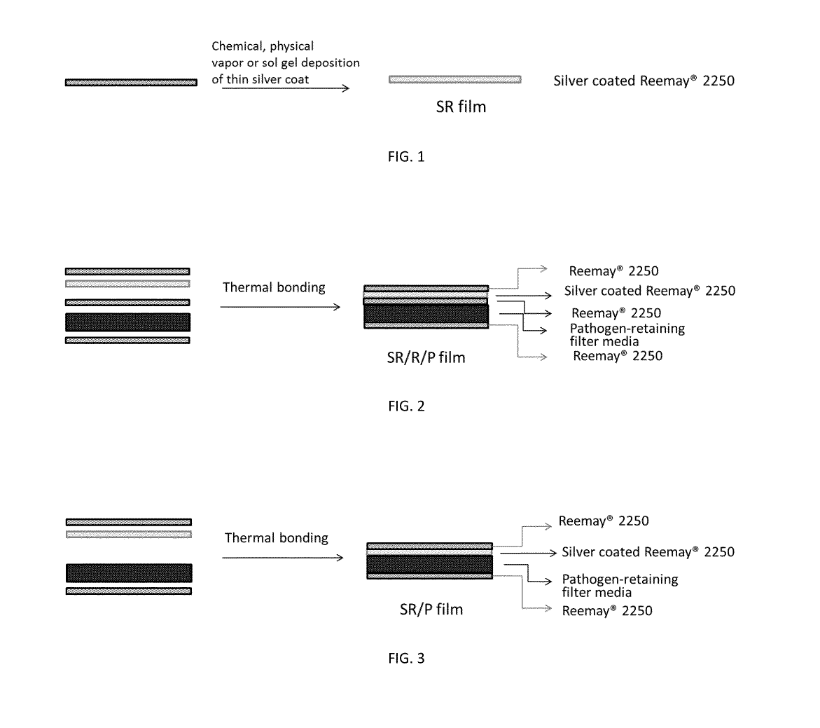

FIG. 1 schematically shows that a spunbonded nonwoven polymeric fabric (Reemay®; R) can be coated with a thin silver film on one or both sides via combustion chemical vapor deposition (CCVD). The resulting silver-coated fabric is designated as a SR film.

In a CCVD process, silver precursor compounds are added to a burning gas. Flame is moved closely above the surface to be coated. The high energy within the flame converts the precursor compounds into silver particles, which readily interact with the fabric, forming a firmly adhering silver deposit. The resulting micro-/nano-structure and thickness of the deposited silver layer can be controlled by varying process parameters, such as, speed of substrate or flame, number of passes, substrate temperature, and distance between flame and substrate.

FIG. 2 schematically shows the use of Reemay® 2250 (R) by thermal bonding to form a filter membrane of silver coated Reemay® (SR) bonded with a Reemay® layer (R) to a pathogen-retaining filter resin (P) further using Reemay® fabric as the outermost layers of the filter membrane. The SR layer can readily kill pathogens retained on the pathogen retaining media to prevent biofouling.

As used herein, biofouling (or “biological fouling”) means accumulation of microorganisms on surfaces or pores of the filter media.

FIG. 3 schematically shows the use of Reemay® 2250 (R) by thermal bonding to form a filter membrane of silver coated Reemay® (SR) bonded without a Reemay® layer (R) to a pathogen-retaining filter resin (P) further using Reemay® fabric to the outermost layers of the filter membrane. The SR layer can also readily kill pathogens retained on the pathogen retaining media to prevent biofouling.

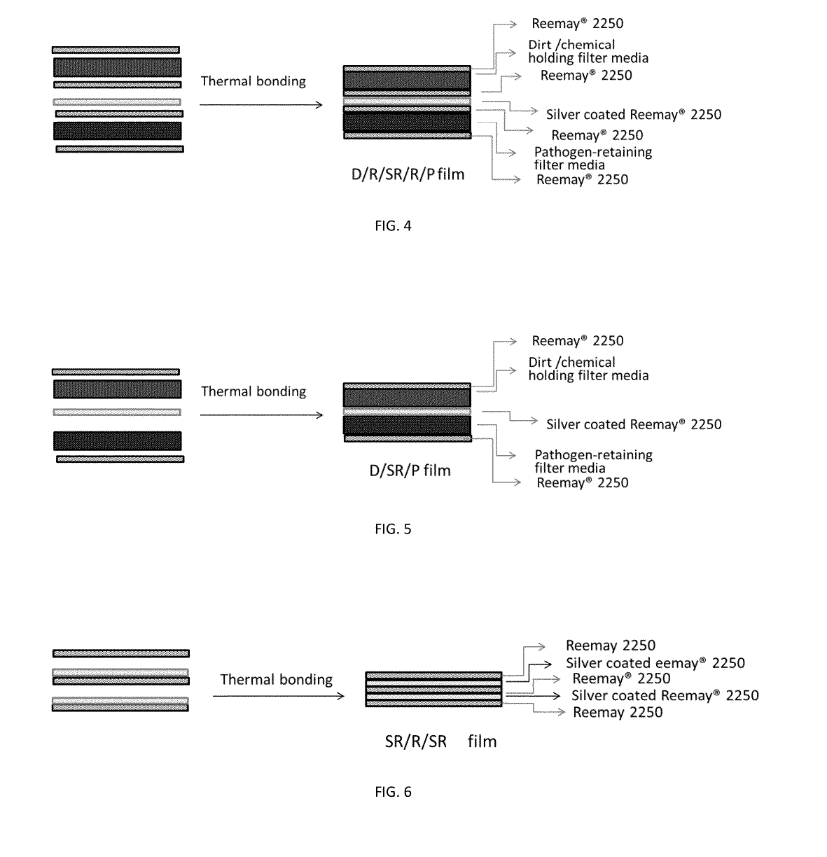

FIG. 4 schematically shows that a SR/R/P assembly can be thermally laminated to a dirt/chemical-holding filter media via Reemay® fabrics. The dirt/chemical filter can be NanoCeram-PAC™ media or other carbon filters. The resulting assembly is designated as a D/R/SR/R/P filter membrane. Use of the dirt/chemical-holding filter prevents SR/R/P layers from prematurely losing disinfection properties due to surface blockage by dirt and/or chemicals.

FIG. 5 schematically shows that a SR/P assembly can be thermally laminated to a dirt/chemical-holding filter media without Reemay® fabrics. The dirt/chemical filter can be NanoCeram-PAC™ media or other carbon filters. The resulting assembly is designated as a D/SR/P filter membrane. Use of the dirt/chemical-holding filter prevents SR/P layers from prematurely losing disinfection properties due to surface blockage by dirt and/or chemicals.

FIG. 6 shows that two SR films can be thermally laminated together via Reemay® fabrics. The resulting assemble is designated as a SR/R/SR film. More than two SR films can be thermally laminated if a better disinfection and filtration performance is needed.

The two thermal lamination steps can be performed concurrently or sequentially. In one embodiment, the SR film is laminated at the same time via Reemay® 2250 layers onto pathogen-retaining media and onto dirt/chemical holding filter media from different sides. In another embodiment, the SR film is first laminated via a Reemay® 2250 layer onto pathogen-retaining media, and then onto dirt/chemical holding filter media via another Reemay® 2250 layer. Alternatively, the SR film is laminated via a Reemay® 2250 layer onto dirt/chemical holding filter media prior to its lamination to pathogen-retaining media via another Reemay® 2250 layer.

As well understood by an ordinarily skilled artisan, the Reemay® 2250 layer used for laminating a biocidal film can be the Reemay® (“R”) layer (if included in the biocidal film) or a separate Reemay® layer.

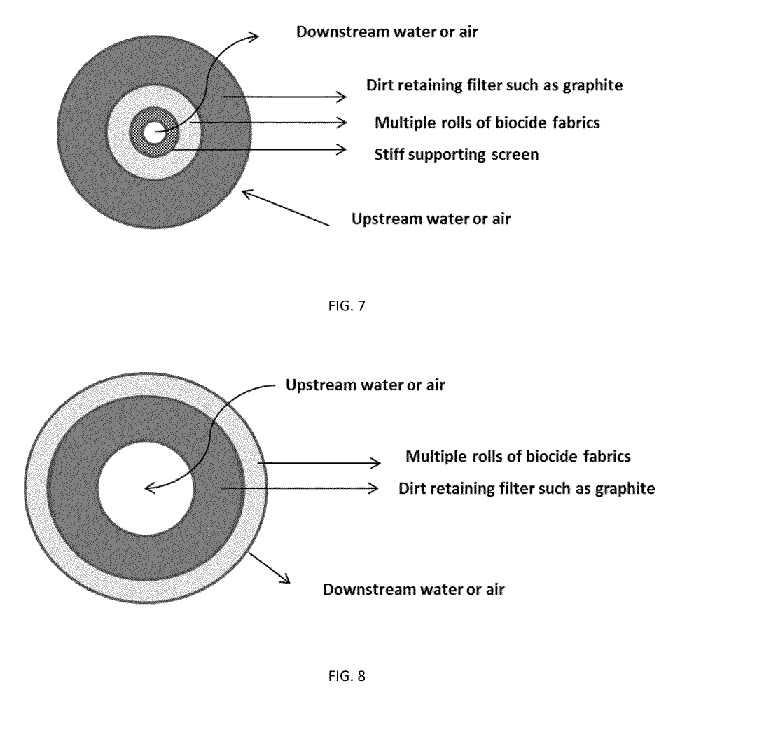

FIG. 7 schematically shows that biocidal fabrics are rolled on a stiff screen roll multiple turns for providing an enhanced pathogen killing efficiency. The biocidal fabrics that can be used herein include, but are not limited to, a SR film.

In certain instances, the biocidal fabrics are composed of thin Reemay® fabrics, so that the total thickness of multiple layers of the biocidal fabrics is still thin, generally between about 10 mil and 30 mil. The use of such a rolled-up structure does not cause a reduced water flow rate or a significant drop in water pressure. In this drawing, the water flow direction is outward from the center of the filter media ring.

FIG. 8 is similar to FIG. 7. In this case, the biocidal fabrics are rolled on the dirt and chemical retaining filter ring. The water flow direct direction is inward toward the center. Likewise, the biocidal fabrics used herein include, for example, a SR film.

Further, the Reemay® 2250 fabrics can be thermally bound to a membrane or other Reemay® fabrics at a relative low temperature, e.g. about 100° to 130° C. with an appropriate pressure. It is appreciated that at such a low temperature, most fabrics or media will not be thermally damaged.

Also disclosed is a method of coating spunbonded nonwoven polymeric fabrics with a thin biocidal coating. The method includes a step of depositing a biocidal material (e.g., a silver film) onto the spunbonded nonwoven polymeric fabrics, resulting in silver-coated spunbonded nonwoven polymeric fabrics with pores essentially free of blockage of the deposited silver film.

As discussed above, the use of silver-coated spunbonded nonwoven polymeric fabrics avoids use of nano-silver particles. Such use of silver-coated fabrics eliminates concerns of silver particle leaching and decreased disinfection efficiency due to larger silver surfaces.

The invention further relates to the use of silver-coated spunbonded nonwoven polymeric fabrics, which are bound to a thermal binding layer to provide pathogen killing efficacy. By using spunbonded nonwoven polymeric fabrics, a high water flow rate and low water pressure drop can be achieved.

Although the application focuses on a potable water filtration system, it is believed that the filter media of the invention works equally well for an air filtration system or other types of fluid filtration systems.

Accordingly, the invention provides more efficient disinfection filter media for fluid filtration, which offers desired properties, such as, a low pressure drop and a high flow rate when in use. Specifically, thin spunbonded nonwoven polymeric fabrics of the invention are coated with a biocidal material, which is then either directly thermally bound onto pathogen-retaining filter media or via a thermal binder onto pathogen-retaining filter media, to provide an enhanced pathogen killing efficacy. Alternatively, filter media containing multiple-rolls of biocidal fabrics also provide good pathogen killing properties.

Still further, the invention relates to a method of preparing filter media for use in a potable water system or an air filtration system. The method comprises thermally binding silver-coated spunbonded nonwoven polymeric fabrics with a thermal binding layer, optionally further with pathogen-retaining media. The thermal binding step can be conducted through processes, such as, hot calendaring, belt calendaring, through-air thermal bonding, ultrasonic bonding, radiant-heat bonding, hot laminators, vacuum bagging with heat, and autoclave with pressure and heat, or a combination thereof. Specifically, the thermal binding step of the invention is designed to avoid or minimize melting fibers contained in the silver-coated fabrics and/or the thermal binding layer.

For example, the autoclave method can be performed by a process comprising the following steps: 1). Lay up fabrics and membranes; 2). Bag the fabrics and membranes on a flat metal support; 3). Vacuum the bag; 4). Place the assembly in an autoclave; 5). Apply pressure and heat for a period of time; 6). Cool the assembly down to ambient temperature and release vacuum; and 7). Check to ensure that thermal bonding is completed.

### INCORPORATION BY REFERENCE

The entire contents of all patents/patent applications and literature references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents are considered to be within the scope of this invention and are covered by the following claims.

1. A method of preparing a filter medium, comprising thermally binding one or more silver-coated spunbonded nonwoven fabrics to at least one membrane selected from the group of a dirt-retaining membrane, a chemical-retaining membrane, and a pathogen-retaining membrane, or a combination thereof, wherein said silver-coated spunbonded nonwoven fabrics are prepared through depositing a silver film onto spunbonded nonwoven fabrics.

2. The method of claim 1, wherein the spunbonded nonwoven fabrics are selected from the group of polyester fabrics, polypropylene fabrics, polyurethane fabrics, polyimide fabrics, or a combination thereof.

3. The method of claim 1, wherein the silver film is deposited through a chemical vapor deposition, a physical vapor deposition, or a sol gel deposition, or a combination thereof.

4. The method of claim 3, wherein said chemical vapor deposition is a vacuum vapor deposition or a combustion chemical vapor deposition.

5. Filter media comprising a microorganism-killing membrane, wherein said microorganism-killing membrane comprises a thermal binding layer and a spunbonded nonwoven fabric coated with silver, and said spunbonded nonwoven fabric is thermally bound to the thermal binding layer, and wherein said filter media does not contain an adhesive layer.

6. The filter media of claim 5, wherein the thermal binding layer comprises spunbonded nonwoven polymeric fabrics.

7. The filter media of claim 6, wherein the spunbonded nonwoven polymeric fabrics are selected from the group of polyester fabrics, polypropylene fabrics, polyurethane fabrics, polyimide fabrics, or a combination thereof.

8. The filter media of claim 7, wherein the spunbonded nonwoven polymeric fabrics comprise Reemay® spunbonded polyester nonwoven fabrics.

9. The filter media of claim 5, wherein the spunbonded nonwoven polymeric fabric coated with silver is selected from the group of polyester fabrics, polypropylene fabrics, polyurethane fabrics, polyimide fabrics, or a combination thereof.

10. The filter media of claim 9, wherein the spunbonded nonwoven polymeric fabric coated with silver comprises Reemay® spunbonded polyester nonwoven fabrics.

11. The filter media of claim 5, wherein said filter media further comprises at least one additional membrane selected from pathogen-retaining filter media, dirt holding filter media, and chemical holding filter media.

12. The filter media of claim 5, wherein said filter media comprises a pathogen-retaining medium, wherein the microorganism-killing membrane is bound to the pathogen-retaining medium via said thermal binding layer or via another thermal binding layer.

13. The filter media of claim 12, wherein said filter media comprises dirt/chemical holding filter media and one or more additional thermal binding layers, and the microorganism-killing membrane, via said additional thermal binding layer(s), is bound to the dirt/chemical holding filter media at a surface different from the surface used for binding with the pathogen-retaining medium.

14. The filter media of claim 5, wherein said filter media comprises at least two of said microorganism-killing membranes, the thermal binding layers in each of said microorganism-killing membranes is coated with silver film, wherein said two microorganism-killing membranes are bound to each other through another thermal binding layer.

15. The filter media of claim 5, wherein the microorganism-killing membrane is in a multiple-turn rolled-up form, and said filter media further comprises dirt/chemical holding filter media.

16. The filter media of claim 15, wherein the rolled-up microorganism-killing membrane is placed inward of the dirt/chemical holding filter media.

17. The filter media of claim 15, wherein the rolled-up microorganism-killing membrane is outside of the dirt/chemical holding filter media.

18. A water purification cartridge comprising the filter media of claim 5.

19. A water purification system for generating potable water comprising the water purification cartridge of claim 18.
